(19) United States
(12) Patent Application Publication
(10) Pub. No.: US 2011/0216255 A1
(43) Pub. Date: Sep. 8, 2011

(54) POLARIZATION DIFFRACTION GRATING, METHOD FOR MANUFACTURING THE SAME, AND OPTICAL PICKUP APPARATUS USING THE POLARIZATION DIFFRACTION GRATING

(75) Inventors: Mitsuhiro MIYAUCHI, Ibaraki-shi (JP); Eiji KOYAMA, Ibaraki-shi (JP); Masahiro KISHIGAMI, Ibaraki-shi (JP)

(73) Assignee: HITACHI MAXELL, LTD., OSAKA (JP)

(21) Appl. No.: 13/036,515

(22) Filed: Feb. 28, 2011

(30) Foreign Application Priority Data
Mar. 5, 2010 (JP) 2010-049238

(51) Int. Cl. G02F 1/133; G02B 5/18

(52) U.S. Cl. 349/19; 349/201; 264/1.31

(57) ABSTRACT

A polarization diffraction grating that enables the polarization direction of incident light and the occurrence direction of diffracted light to be freely selected without being restricted by the material of a substrate is provided. A polarization diffraction grating includes a transparent substrate, a polymer liquid crystal layer that is adhered onto the transparent substrate via an adhesive layer, and that has a first concavity/convexity structure that diffracts incident light formed on a face opposite to the adhesive layer, and an optically isotropic material layer provided to fill the first concavity/convexity structure. A second concavity/convexity structure made up of a plurality of stripe grooves disposed parallel to each other is further formed on the face of the polymer liquid crystal layer on which the first concavity/convexity structure is formed, and liquid crystal molecules in the polymer liquid crystal layer are oriented in the groove lengthwise direction of the second concavity/convexity structure.

### BACKGROUND

Aspects of the disclosure relate to a polarization diffraction grating utilized as, for instance, a diffraction grating or a polarizing filter of an optical pickup apparatus that records/reproduces information in/from an optical information recording medium, and a method for manufacturing the same. Further, the present disclosure relates to an optical pickup apparatus that uses such a polarization diffraction grating.

A polarization diffraction grating using polymer liquid crystal is utilized in, for example, an optical pickup apparatus of an optical disk apparatus, as a diffraction grating that forms sub beams for tracking or a polarizing filter that prevents light reflected by an optical disc from returning to a laser emission layer. There is a demand for such a polarization diffraction grating to enable the polarization direction of incident light and the occurrence direction of diffracted light to be freely selected in order to improve the degree of freedom in designing in the case where the polarization diffraction grating is incorporated in the optical pickup apparatus.

JP H11-125710A discloses a method for manufacturing a polarization diffraction grating including polymer liquid crystal and an optically isotropic material by providing an orienting film that has been subjected to rubbing processing on a glass substrate, applying a polymer liquid crystal film thereon, and thereafter forming a diffraction grating pattern having concavity and convexity on this polymer liquid crystal film using a photolithography method and a dry etching method, filling the diffraction grating pattern having concavity and convexity with the optically isotropic material, and attaching it together with another substrate. According to this method, because the diffraction grating pattern having concavity and convexity is formed after the polymer liquid crystal has been oriented, the lengthwise direction of grating grooves can be arbitrarily selected irrespective of the orientation direction of the liquid crystal. Thus, according to the method disclosed in JP H11-125710A, it is possible to provide a polarization diffraction grating that enables the polarization direction of incident light and the occurrence direction of diffracted light to be freely selected.

However, the annealing baking temperature for an organic film, such as a polyimide film used as an orienting film in JP H11-125710A and the like, is extremely high compared with the heat-resistant temperature of other organic materials. Thus, it is necessary to use a member made of a material with favorable heat resistance, such as glass, as a substrate, which results in an increase in weight and cost.

### SUMMARY

Aspects of the present disclosure relate to a polarization diffraction grating that enables the polarization direction of incident light and the occurrence direction of diffracted light to be freely selected without being restricted by the material of a substrate, a method for manufacturing the same, and an optical pickup apparatus using the polarization diffraction grating.

A polarization diffraction grating according to the present disclosure may be configured so as to be a polarization diffraction grating including a polymer liquid crystal layer that has a first concavity/convexity structure having a function of diffracting incident light formed on one face, and an optically isotropic material layer that is provided so as to fill the first concavity/convexity structure, wherein a second concavity/convexity structure is further formed on the one face of the polymer liquid crystal layer, and liquid crystal molecules in the polymer liquid crystal layer are oriented in a groove lengthwise direction of the second concavity/convexity structure.

According to the above configuration, it is possible to realize, without providing an orienting film, the state where the liquid crystal molecules in the polymer liquid crystal layer are oriented irrespective of the groove lengthwise direction of the first concavity/convexity structure having a function of diffracting incident light. As a result, the direction of optical anisotropy obtained by the liquid crystal and the occurrence direction of diffracted light at the first concavity/convexity structure can be set independently. Thus, it is possible to provide a polarization diffraction grating that enables the polarization direction of incident light and the occurrence direction of diffracted light to be freely selected. Further, it is not necessary to provide an orienting film, and a high temperature process, such as annealing baking, is unnecessary when the polarization diffraction grating is manufactured. Thus, it is possible to provide a light-weight and low-cost polarization diffraction grating using a plastic substrate.

A method for manufacturing the polarization diffraction grating according to the present disclosure is a method for manufacturing a polarization diffraction grating, including the steps of: obtaining a polymer liquid crystal layer on which a diffraction structure having concavity and convexity is formed, by filling a mold on which a concavity/convexity structure is formed with polymerizable liquid crystal, and polymerizing and curing the polymerizable liquid crystal; detaching the polymer liquid crystal layer from the mold; and obtaining an optically isotropic material layer by filling the diffraction structure having concavity and convexity with an optically isotropic material, and reactively curing the optically isotropic material, and as the mold, a mold in which an orientation induction structure that induces orientation of liquid crystal molecules is formed on the surface of the concavity/convexity structure is used.

According to the above method, the liquid crystal molecules can be oriented irrespective of the lengthwise direction of the grating grooves of the diffraction structure having concavity and convexity, and consequently, the direction of optical anisotropy obtained by the liquid crystal and the occurrence direction of diffracted light at the diffraction structure having concavity and convexity can be independently set. Thus, it is possible to manufacture a polarization diffraction grating that enables the polarization direction of incident light and the occurrence direction of diffracted light to be freely selected. Further, it is not necessary to provide an orienting film when liquid crystal molecules are oriented, and a high temperature process, such as annealing baking, is unnecessary. Thus, it is possible to manufacture, using a plastic substrate, a light-weight and low-cost polarization diffraction grating.

An optical pickup apparatus according to the present disclosure is configured so as to be an optical pickup apparatus for recording/reproducing information by concentrating light from a light source onto an information recording face of an optical information recording medium via an objective lens, the optical pickup apparatus including the polarization diffraction grating according to the present disclosure disposed in an optical path between the light source and the objective lens.

According to the above configuration of the optical pickup apparatus, it is possible to achieve a reduction in the weight and cost of the optical pickup apparatus itself by using the light-weight and low-cost polarization diffraction grating using a plastic substrate.

According to the present disclosure, it is possible to provide a polarization diffraction grating that enables the polarization direction of incident light and the occurrence direction of diffracted light to be freely selected without being restricted by the material of a substrate.

### BRIEF DESCRIPTION OF THE DRAWINGS

FIG. 1 is a schematic cross-sectional view showing a polarization diffraction grating according to an exemplary embodiment.

FIG. 2 is a schematic plan view showing the oriented state of liquid crystal molecules in the polarization diffraction grating according to the exemplary embodiment.

FIG. 3 is a schematic perspective view showing the configuration of a mold used in a method for manufacturing the polarization diffraction grating according to the exemplary embodiment.

FIG. 4 is a process cross-sectional view showing the method for manufacturing the polarization diffraction grating according to the embodiment.

FIG. 5 is a schematic configuration diagram showing an optical pickup apparatus according to the embodiment.

### DETAILED DESCRIPTION OF EMBODIMENTS

In the above-described configuration of the polarization diffraction grating of the present disclosure, the copy impression of the orientation induction structure that induces orientation in the polymer liquid crystal layer has a shape that suppresses occurrence of diffracted light at a wavelength of light to be used. Thus, the occurrence of unnecessary diffracted light can be suppressed.

In the above-described method for manufacturing the polarization diffraction grating of the present disclosure, the orientation induction structure is made up of, for example, a plurality of stripe-shaped grooves disposed parallel to each other, and a pitch of the orientation induction structure is set to be smaller than a pitch of the concavity/convexity structure. Thus, the degree of orientation of the liquid crystal molecules induced by the orientation induction structure can be increased.

In the above-described configuration of the optical pickup apparatus of the present disclosure, the light source is, for example, a semiconductor laser, and the polarization diffraction grating is, for example, disposed so as to be adjacent to the semiconductor laser along an optical axis. Here, “being adjacent along the optical axis” is a concept that includes the case where the polarization diffraction grating is disposed in contact with the semiconductor laser and the case where the polarization diffraction grating is disposed so as to be separated from the semiconductor laser without having another member interposed therebetween. Thus, it is possible to suppress laser noise in the optical pickup apparatus by minimizing laser light that is reflected by the information recording face of an optical information recording medium and returns to the semiconductor laser.

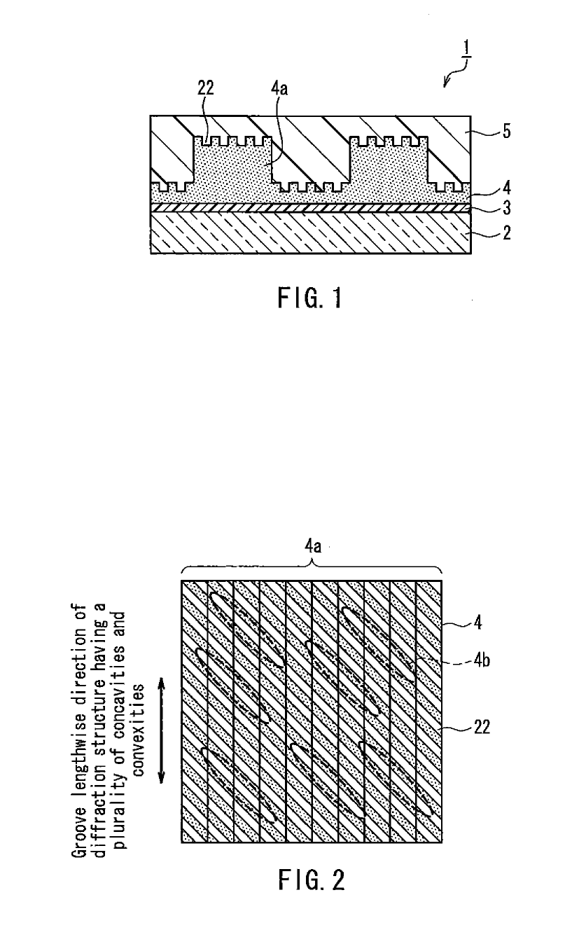

The configuration of a polarization diffraction grating according to an exemplary embodiment is described with reference to FIGS. 1 to 3.

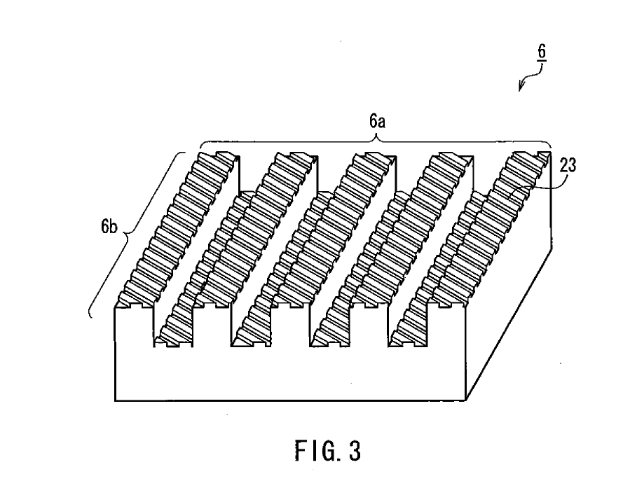

FIG. 1 is a schematic cross-sectional view showing a polarization diffraction grating according to an exemplary embodiment, FIG. 2 is a schematic plan view showing the oriented state of liquid crystal molecules in the polarization diffraction grating, and FIG. 3 is a schematic perspective view showing the configuration of a mold used in a method for manufacturing the polarization diffraction grating.

As shown in FIGS. 1 and 2, a polarization diffraction grating 1 according to the present exemplary embodiment is provided with a transparent substrate 2, a polymer liquid crystal layer 4 that is adhered onto one face of the transparent substrate 2 via an adhesive layer 3 and has a first concavity/convexity structure (diffraction structure having a plurality of concavities and convexities) 4a having a function of diffracting incident light formed on a face opposite to the adhesive layer 3, and an optically isotropic material layer 5 that is provided so as to fill the pluralities of concavities and convexities of the diffraction structure 4a of the polymer liquid crystal layer 4. Further, a second concavity/convexity structure, which is made up of a plurality of stripe-shaped grooves (stripe grooves) 22 disposed parallel to each other, is formed on the face of the polymer liquid crystal layer 4 on which the diffraction structure 4a is formed, and liquid crystal molecules 4b in the polymer liquid crystal layer 4 are oriented in the groove lengthwise direction of the second concavity/convexity structure (lengthwise direction of the stripe grooves 22).

The diffraction structure 4a formed on the polymer liquid crystal layer 4 can be obtained by filling, for example, a mold 6 on which a concavity/convexity structure 6a is formed in advance (as shown in FIG. 3) with polymerizable liquid crystal, and polymerizing and curing the polymerizable liquid crystal. Specifically, the diffraction structure 4a is a copy of the concavity/convexity structure 6a of the mold 6.

The shape of the diffraction structure 4a formed on the polymer liquid crystal layer 4 determines the desired diffraction characteristics. For example, the angle of diffraction can be adjusted by changing the pitch in accordance with the wavelength of light to be used, and the diffraction efficiency can be adjusted by changing the groove depth in accordance with the wavelength of light to be used. Further, the shape of the convex portions of the diffraction structure 4a is not limited to a substantially rectangular shape as shown in FIG. 1. For example, the shape of the convex portions can also be a step shape or a saw-toothed shape.

In the present exemplary embodiment, for convenience, liquid crystal that is not polymerized is referred to as “polymerizable liquid crystal,” and liquid crystal that has been polymerized and has become a polymer is referred to as “polymer liquid crystal.” The polymerizable liquid crystal used in the present exemplary embodiment is a composition including, for example, a monomer, an oligomer, or another reactive compound that shows liquid crystallinity, for instance, and may be obtained by adding a functional group that has polymerizability, such as an acryl group or an epoxy group, at the end of a mesogenic group that exhibits a liquid crystal state. Such polymerizable liquid crystal can show various states of orientation, such as homogeneous orientation, homeotropic orientation, and cholesteric orientation. With regard to the polarization diffraction grating 1, if a polymerizable liquid crystal that shows a homogeneous orientation is used, optical anisotropy can to be exhibited in an in-plane direction. Means for curing polymerizable liquid crystal may include, for example, photo-curing by emitting visible light, UV (ultraviolet) light, or the like, and heat curing by heating. Further, photo-curing provides a means of curing that is unlikely to be restricted by the phase transition temperature of the polymerizable liquid crystal.

As shown in FIG. 3, a plurality of stripe grooves 23, which each form an angle of, for example, 45 degrees relative to the groove lengthwise direction of the concavity/convexity structure 6a, are formed on the surface of the concavity/convexity structure 6a of the mold 6. The plurality of stripe grooves 23 provide an orientation induction structure 6b for orienting the liquid crystal molecules in the polymerizable liquid crystal (for inducing orientation of the liquid crystal molecules) in the lengthwise direction of the stripe grooves 23. For example, as described above, the polymerizable liquid crystal is polymerized and cured using the mold 6, thereby achieving the state where the liquid crystal molecules 4b in the polymer liquid crystal layer 4 are oriented in the direction that forms an angle of, for example, 45 degrees (the lengthwise direction of the stripe grooves 22 that are the copy impression formed by the stripe grooves 23 of the mold 6) relative to the groove lengthwise direction of the diffraction structure 4a (as shown in FIG. 2). Accordingly, it is not necessary to provide an orienting film such as a polyimide film when the liquid crystal molecules 4b in the polymer liquid crystal layer 4 are oriented.

As described above, it is not necessary to provide an orienting film, such as a polyimide film, when obtaining the polarization diffraction grating 1 according to the present exemplary embodiment, and a high temperature process, such as annealing baking is unnecessary. Thus, a material with a low heat-resistant temperature can be used as the material of the transparent substrate 2. For example, glass or plastic can be used as the material of the transparent substrate 2. Specifically, it is possible to use plastic that is light-weight and low in cost, examples of which may include thermoplastic typified by polycarbonate resin and polyolefin resin, and thermosetting plastic typified by a cured substance of epoxy thermosetting material and a cured substance of acrylic photopolymerizable material. As a result, it is possible to provide the polarization diffraction grating 1 that is light-weight and low in cost.

Alternatively, if glass is used as the material of the transparent substrate 2, it is necessary to consider the refractive index of the glass. The refractive index of ordinary glass can range from about 1.4 to 2.1. However, because the adhesive layer 3 is made of resin, the refractive index thereof can range from about 1.4 to 1.6. If the difference between the refractive index of the glass substrate and the adhesive layer 3 is large, reflection occurs at the interface between the glass substrate and the adhesive layer 3, which causes a drop in the transmissivity. Accordingly, if glass is used as the material of the transparent substrate 2, it is desirable to use glass having a refractive index close to the refractive index of the adhesive layer 3.

Further, it is also possible to substitute other optical elements for the transparent substrate 2. For example, in an optical pickup apparatus, phase difference plates, such as a quarter wave plate that converts linearly polarized light into circularly polarized light and a half wave plate that rotates the direction of linearly polarized light by 90 degrees, and a phase difference film, may be used. These phase difference plates are made of a material such as crystal, polycarbonate resin, or polyvinyl alcohol resin, and can be used as the transparent substrate 2. In this way, by substituting other optical elements for the transparent substrate 2, a plurality of optical elements can be composited, thereby achieving a smaller size for the optical pickup apparatus.

The optically isotropic material layer 5 may be made of, for example, photopolymerizable acrylic resin or photopolymerizable epoxy resin. In particular, if acryl-modified liquid crystal is used as polymerizable liquid crystal that forms the polymer liquid crystal layer 4, by using acrylic ultraviolet curable resin as the material of the optically isotropic material layer 5, strong adhesion can be obtained between the polymer liquid crystal layer 4 and the optically isotropic material layer 5. Further, polarized light separating performance due to the direction of linear polarization of incident light can be increased by bringing the refractive index of the optically isotropic material layer 5 close to the ordinary light refractive index (no) of the polymer liquid crystal layer 4 or the extraordinary light refractive index (ne) thereof.

Photo-curable resin may be used as the adhesive used for the adhesive layer 3. In particular, if acryl-modified liquid crystal is used as the polymerizable liquid crystal that forms the polymer liquid crystal layer 4, strong adhesion can be obtained between the polymer liquid crystal layer 4 and the adhesive layer 3 by using, for example, acrylic ultraviolet curable resin as the adhesive used for the adhesive layer 3.

Although the above is a description of the configuration of the polarization diffraction grating 1 according to the present exemplary embodiment with reference to FIGS. 1 to 3, the polarization diffraction grating of the present disclosure is not limited to this configuration. For example, the polarization diffraction grating can be configured as, for example, a composite diffraction element having another diffraction grating formed on the face of the transparent substrate 2 opposite to the adhesive layer 3 or the face of the optically isotropic material layer 5 opposite to the polymer liquid crystal layer 4. Further, a configuration can also be adopted in which the adhesive layer 3, the polymer liquid crystal layer 4, and the optically isotropic material layer 5 are sandwiched using another transparent substrate in order to improve rigidity and wave front aberration performance. Further, a configuration can also be adopted in which anti-reflection processing is performed by providing a dielectric film and a fine structure on the surface that is in contact with the air. Further, a configuration may also be adopted in which, for example, the transparent substrate 2 is omitted.

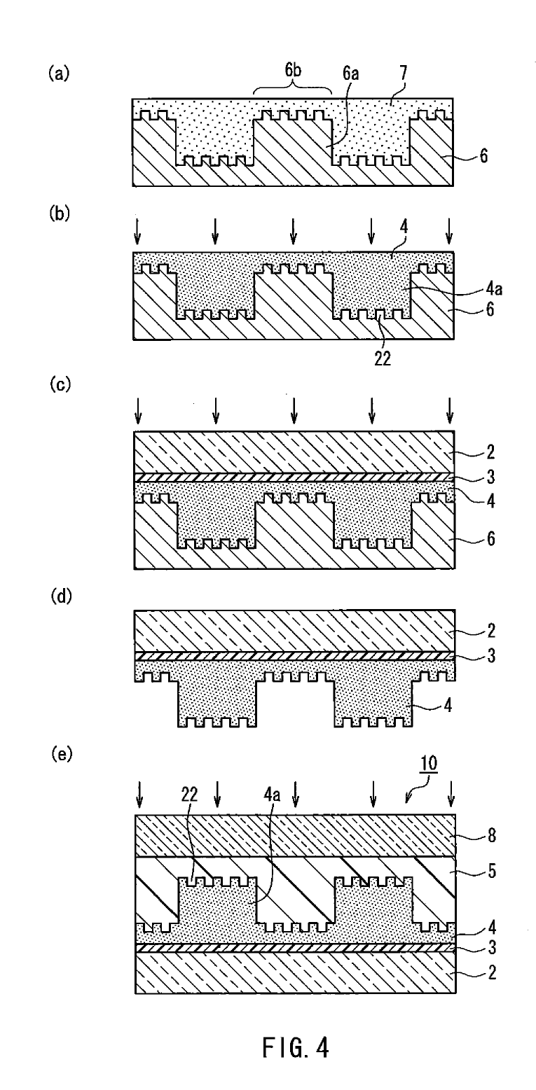

FIG. 4 is a process cross-sectional view showing a method for manufacturing a polarization diffraction grating according to the exemplary embodiment of the present disclosure.

In the manufacturing method of the present exemplary embodiment, the mold 6 (see FIG. 3), as described above for forming the polymer liquid crystal layer 4, is used. As shown in FIG. 3, the concavity/convexity structure 6a for copying the diffraction structure 4a on the polymer liquid crystal layer 4, and the orientation induction structure 6b made up of the plurality of stripe grooves 23 for orienting liquid crystal molecules in the polymerizable liquid crystal (for inducing orientation of the liquid crystal molecules) are formed on the mold 6. The orientation induction structure 6b can be freely formed regardless of the direction of the grooves of the concavity/convexity structure 6a, and the liquid crystal molecules in the polymerizable liquid crystal are oriented in the lengthwise direction of the stripe grooves 23 of the orientation induction structure 6b. Thus, if the mold 6 having the above configuration is used, liquid crystal molecules can be oriented irrespective of the lengthwise direction of the grating grooves of the diffraction structure 4a having concavity and convexity, and consequently, the direction of optical anisotropy obtained by the liquid crystal and the occurrence direction of the diffracted light at the diffraction structure 4a having concavity and convexity can be set independently. Thus, it is possible to provide the polarization diffraction grating that enables the polarization direction of incident light and the occurrence direction of diffracted light to be freely selected. In particular, in the orientation achieved by grooves, because the degree of orientation of liquid crystal molecules increases as the pitch decreases, the pitch of the orientation induction structure 6b is set to be smaller than the pitch of the concavity/convexity structure 6a. Note that if the polymer liquid crystal layer 4 is formed using the mold 6, as described above, the orientation induction structure 6b is copied on the surface of the diffraction structure 4a as the plurality of stripe grooves 22 (as shown in FIG. 1), and thus there is the possibility that unnecessary diffracted light occurs due to this copy impression. In view of this, the orientation induction structure 6b may have a shape that suppresses the occurrence of unnecessary diffracted light. For example, if the orientation induction structure 6b is made up of the plurality of stripe grooves 23 as in the present exemplary embodiment, the pitch of the grooves is made smaller than the wavelength of light to be used, periodicity is eliminated, or the groove depth is set so as to prevent the occurrence of phase difference in transmitted light.

Below, a method for manufacturing the polarization diffraction grating is described in detail with reference to specific examples.

First, the concavity/convexity structure 6a having a pitch of 100 μm and a groove width of 50 μm was formed in a 10 mm×10 mm area on a silicon (Si) substrate, using a photolithography method and a dry etching method. Then, using an electron beam lithography method and a dry etching method, the orientation induction structure 6b made up of the plurality of stripe grooves 23 that each form an angle of 45 degrees relative to the groove lengthwise direction of the concavity/convexity structure 6a was formed on the surface of the concavity/convexity structure 6a, so as to have a pitch of 0.32 μm and a groove width of 0.16 μm, thereby obtaining the mold 6 (see FIG. 3).

Next, as shown in FIG. 4(a), polymerizable liquid crystal 7 diluted with a solvent, for example, RMS03-001C (manufactured by Merck & Co., Inc.) was applied onto the face of the mold 6 on which the concavity/convexity structure 6a was formed using a spin coating method, and thereafter the solvent was heated and dried.

Next, as shown in FIG. 4(b), the temperature of the polymerizable liquid crystal 7 was returned to room temperature, and thereafter the polymerizable liquid crystal 7 was polymerized and cured by being irradiated with ultraviolet rays mainly having a wavelength of, for example 365 nm in the nitrogen gas atmosphere, thereby forming the polymer liquid crystal layer 4. Accordingly, the concavity/convexity structure 6a of the mold 6 was copied, thereby forming the diffraction structure 4a on the polymer liquid crystal layer 4, and further the liquid crystal molecules 4b in the polymer liquid crystal layer 4 were oriented in the direction that formed an angle of 45 degrees relative to the groove lengthwise direction of the diffraction structure 4a (see FIG. 2). Further, the stripe grooves 22 were formed as the copy impression by the stripe grooves 23 of the mold 6 on the surface of the polymer liquid crystal layer 4 on which the diffraction structure 4a was formed.

Next, as shown in FIG. 4(c), liquid ultraviolet curable resin was applied onto the cured polymer liquid crystal layer 4, and a polycarbonate substrate, which acts as the transparent substrate 2, was attached thereon and pressed. Further, the liquid ultraviolet curable resin was reactively cured by being irradiated with ultraviolet rays mainly having a wavelength of, for example, 365 nm, thereby forming the adhesive layer 3. Note that as the liquid ultraviolet curable resin, which forms the adhesive layer 3 includes, for example, a mixture of 20 parts by weight of dicyclopentadienyl hexaacrylate (manufactured by Kyoeisha Chemical Co., Ltd.), 80 parts by weight of a mixture of isobornyl acrylate (manufactured by Kyoeisha Chemical Co., Ltd.) and phenoxy acrylate (manufactured by Kyoeisha Chemical Co., Ltd.) serving as a refractive-index adjuster, and 3 parts by weight of IRGACURE 184 (manufactured by Ciba Specialty Chemicals) serving as a polymerization initiator was used. Further, the refractive index of the adhesive layer 3 obtained by curing the above mixture was set to the ordinary light refractive index 1.53 of the polymer liquid crystal layer 4.

Next, as shown in FIG. 4(d), the polymer liquid crystal layer 4 integrated with the transparent substrate 2 via the adhesive layer 3 was detached (released) from the mold 6.

Next, as shown in FIG. 4(e), the same liquid ultraviolet curable resin used as the material of the adhesive layer 3 was applied onto the face of the polymer liquid crystal layer 4 on which the diffraction structure 4a was formed, and a polycarbonate substrate used as another transparent substrate 8 was attached thereon and pressed. Further, the liquid ultraviolet curable resin was reactively cured by being irradiated with ultraviolet rays mainly having a wavelength of 365 nm, thereby forming the optically isotropic material layer 5.

Although the above-described exemplary method uses two transparent substrates, a polarization diffraction grating can be manufactured through substantially the same processes where one transparent substrate is used as shown in FIG. 1. In this case, instead of the process in FIG. 4(e), a process in which an optically isotropic material is applied using a spin coating method or the like onto the face of the polymer liquid crystal layer 4 on which the diffraction structure 4a having concavity and convexity is formed, or a process in which an optically isotropic material is applied onto that face, and thereafter pressed with a mold and released therefrom can be used.

If two transparent substrates are used, the degree of orientation of the liquid crystal molecules can be further increased by performing orientation processing on one of the transparent substrates. Further, a twisted orientation can also be induced by causing a shift between the lengthwise direction of the stripe grooves 23 of the orientation induction structure 6b of the mold 6 and the direction in which orientation processing is performed on the transparent substrate.

The process in FIG. 4(c) in which the transparent substrate 2 is attached onto the cured polymer liquid crystal layer 4, pressed, and the like may be omitted. In the case where this process in FIG. 4(c) is omitted, it is sufficient to directly detach the cured polymer liquid crystal layer 4 from the mold 6.

The polarization diffraction grating 10 obtained as described above was interposed between two polarizers orthogonal to each other, and crossed Nicols observation was performed. When the polarization diffraction grating 10 was rotated about the optical axis, a change in the amount of transmitted light was observed.

The polarization diffraction grating 10 obtained as described above was irradiated with laser light having a wavelength of 660 nm through a half wave plate. Then, when the polarization direction of the entering laser light (the direction of incident polarized light) was rotated, the zero-order light intensity changed, and diffracted light that occurred in the direction orthogonal to the groove lengthwise direction of the diffraction structure 4a was observed. On the other hand, diffracted light in the direction orthogonal to the lengthwise direction of the stripe grooves 22, which were the copy impression formed by the stripe grooves 23 of the orientation induction structure 6b of the mold 6, did not occur. Next, when checking the direction of incident polarized light, it was determined that the zero-order light intensity was the maximum at the direction orthogonal to the lengthwise direction of the stripe grooves 22 (the direction that formed an angle of 45 degrees relative to the groove lengthwise direction of the diffraction structure 4a having concavity and convexity). In contrast, the direction of incident polarized light at which the zero-order light intensity was the minimum was determined to be the lengthwise direction of the stripe grooves 22. Accordingly, it was confirmed that in the polarization diffraction grating 10 obtained in the present example, the lengthwise direction of the stripe grooves 22 corresponded to the extraordinary light component (delayed phase axis direction), whereas the direction orthogonal to the lengthwise direction of the stripe grooves 22 corresponded to the ordinary light component (advanced phase axis direction), and the liquid crystal molecules were oriented in the lengthwise direction of the stripe grooves 22.

In a first comparative example, a polarization diffraction grating was manufactured using a procedure similar to that of the above example and used a mold in which only a concavity/convexity structure having a pitch of 100 μm and a groove width of 50 μm was formed, and an orientation induction structure for liquid crystal orientation was not formed.

The polarization diffraction grating obtained in the first comparative example was interposed between two polarizers orthogonal to each other, and crossed Nicols observation was performed. However, even when this polarization diffraction grating was rotated about an optical axis, the transmission of light was not seen and light extinction was maintained.

In a second comparative example, a polarization diffraction grating was manufactured using a procedure similar to that of the above example and used a mold in which only a concavity/convexity structure having a pitch of 3 μm and a groove width of 1.5 μm was formed, and an orientation induction structure for liquid crystal orientation was not formed.

The polarization diffraction grating obtained in the second comparative example was interposed between two polarizers orthogonal to each other, and crossed Nicols observation was performed. When this polarization diffraction grating was rotated about an optical axis, a change in the amount of transmitted light was observed.

Further, the polarization diffraction grating obtained in the second comparative example was irradiated with laser light having a wavelength of 660 nm through a half wave plate. Then, when the direction of incident polarized light was rotated, the zero-order light intensity changed, and diffracted light that occurred in the direction orthogonal to the groove lengthwise direction of the diffraction structure was observed. Next, when checking the direction of incident polarized light, it was determined that the zero-order light intensity was the maximum at the direction orthogonal to the groove lengthwise direction of the diffraction structure. In contrast, the direction of incident polarized light at which the zero-order light intensity was the minimum was determined to be the groove lengthwise direction of the diffraction structure. Accordingly, it was confirmed that, in the polarization diffraction grating obtained in the second comparative example, the groove lengthwise direction of the diffraction structure corresponds to the extraordinary light component (delayed phase axis direction), whereas the direction orthogonal to the groove lengthwise direction of the diffraction structure corresponds to the ordinary light component (advanced phase axis direction), and the liquid crystal molecules were oriented in the groove lengthwise direction of the diffraction structure.

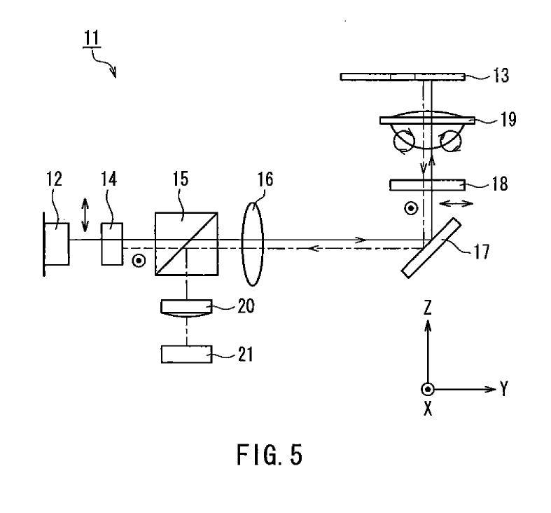

Next, the configuration of an optical pickup apparatus according to the exemplary embodiment is described with reference to FIG. 5.

FIG. 5 is a schematic configuration diagram showing an optical pickup apparatus according to the embodiment of the present disclosure. Note that the XYZ three-dimensional orthogonal coordinate system is set as shown in FIG. 5.

As shown in FIG. 5, an optical system of an optical pickup apparatus 11 according to the present exemplary embodiment includes a composite diffraction element 14, a polarization beam splitter 15, a collimating lens 16, a raising mirror 17, a quarter wave plate 18, and an objective lens 19, which are disposed in the stated order in the optical path from a semiconductor laser 12 serving as a light source to an optical disk 13 serving as an optical information recording medium. The composite diffraction element 14 includes a polarization diffraction grating portion (not shown) serving as a polarizing filter made up of the polarization diffraction grating according to the exemplary embodiment described above (for example, the polarization diffraction grating 1 or 10) and an isotropic diffraction grating portion (not shown) that is independent of the direction of incident polarized light. The collimating lens 16 collimates laser light from the semiconductor laser 12. The raising mirror 17 bends the optical path of laser light emitted in the Y axis direction from the collimating lens 16 into the Z axis direction. The quarter wave plate 18 converts laser light from the semiconductor laser 12 from linearly polarized light into circularly polarized light. The objective lens 19 concentrates laser light converted into circularly polarized light on the information recording face of the optical disk 13. Further, a detection lens 20 and a photodetector 21 are disposed to the side of the polarization beam splitter 15 (in the X axis direction). Note that in FIG. 5, for convenience and in order to clearly show the positional relationship between the polarization beam splitter 15, the detection lens 20, and the photodetector 21, the detection lens 20 and the photodetector 21 are drawn as being disposed vertically below the polarization beam splitter 15 (in the −Z axis direction).

Next, a reproduction operation performed on the optical disk 13 in the present exemplary embodiment is described.

Laser light (solid line) emitted in the Y axis direction from the semiconductor laser 12 is linearly polarized light, and enters the composite diffraction element 14. The laser light that has entered the composite diffraction element 14 passes through the isotropic diffraction grating portion of the composite diffraction element 14, and is diffracted into three beams for tracking control. In the polarization diffraction grating portion of the composite diffraction element 14, the direction of incident polarized light at which the zero-order light intensity is the maximum is the direction orthogonal to the lengthwise direction of the stripe grooves 22, as described above. Thus, if the composite diffraction element 14 is disposed such that the lengthwise direction of the stripe grooves 22 and the polarization direction of laser light from the semiconductor laser 12 are orthogonal to each other, laser light from the semiconductor laser 12 passes through with almost no diffraction in the polarization diffraction grating portion. If, for example, a half wave plate is also included with the composite diffraction element 14, the polarization direction of laser light from the semiconductor laser 12 can be rotated 90 degrees. The laser light from the composite diffraction element 14 passes through the polarization beam splitter 15 as it is, and thereafter is collimated by the collimating lens 16 so as to be parallel light. The optical path of the collimated laser light is bent into the Z axis direction by the raising mirror 17. Then, the laser light bent in the Z axis direction is converted by the quarter wave plate 18 from linearly polarized light into circularly polarized light, and thereafter concentrated on the information recording face of the optical disk 13 by the objective lens 19.

Laser light (dashed dotted line) reflected by the information recording face of the optical disk 13 passes through the objective lens 19 again, and becomes linearly polarized light that is rotated 90 degrees from the polarization direction of the outbound light due to the effect of the quarter wave plate 18. The optical path of the laser light that has passed through the quarter wave plate 18 is bent into the −Y axis direction by the raising mirror 17, and thereafter passes through the collimating lens 16, and enters the polarization beam splitter 15. Then, the laser light that has entered the polarization beam splitter 15 is reflected by the polarization beam splitter 15, and the optical path thereof is bent into the X axis direction (for illustrative purposes, the −Z axis direction in FIG. 5). The laser light bent into the X axis direction passes through the detection lens 20 and enters the photodetector 21. Information from the optical disk 13 is reproduced by the above operation.

There is the possibility that laser light (dashed line) that is not reflected by the polarization beam splitter 15 returns to the semiconductor laser 12 (hereinafter, laser light that returns to the semiconductor laser 12 is referred to as “return laser light”), and causes laser noise. However, the polarization direction of this return laser light is in the direction rotated 90 degrees relative to the direction of the outbound laser light, and thus the return laser light is diffracted by the polarization diffraction grating portion of the composite diffraction element 14. Specifically, the laser light that returns to the semiconductor laser 12 is minimized by the polarization diffraction grating portion of the composite diffraction element 14.

As described above, because laser light that is reflected by the information recording face of the optical disk 13 and returns to the semiconductor laser 12 can be minimized by using the polarization diffraction grating according to the present exemplary embodiment as a polarizing filter of the optical pickup apparatus 11, laser noise in the optical pickup apparatus 11 can be suppressed.

In the optical pickup apparatus 11 according to the present exemplary embodiment, the case of using the composite diffraction element 14 having the polarization diffraction grating portion made up of the polarization diffraction grating according to the present exemplary embodiment and the isotropic diffraction grating portion that does not have dependence on the direction of incident polarized light has been described as an example. However, the polarization diffraction grating portion and the isotropic diffraction grating portion may be constituted separately and independently. For example, the polarization diffraction grating according to the present exemplary embodiment (for example, the polarization diffraction grating 1 or 10) may be disposed between the semiconductor laser 12 and the polarization beam splitter 15, and an isotropic diffraction grating may be disposed separately therefrom.

A polarization diffraction grating of the present disclosure can be manufactured without being restricted by the material of a substrate, and the polarization direction of incident light and the occurrence direction of diffracted light can be freely selected. Thus, it is useful as, for instance, a polarizing filter of an optical pickup apparatus for which a reduction in weight and cost is desired.

The disclosure may be embodied in other forms without departing from the spirit or essential characteristics thereof. The exemplary embodiment disclosed in this application is to be considered in all respects as illustrative and not limiting. The scope of the disclosure is indicated by the appended claims rather than by the foregoing description, and all changes which come within the meaning and range of equivalency of the claims are intended to be embraced therein.

What is claimed is:

1. A polarization diffraction grating comprising:
a polymer liquid crystal layer having a first concavity/convexity structure configured to diffract light incident on a face of the first concavity/convexity structure;
an optically isotropic material layer that fills the first concavity/convexity structure; and
a second concavity/convexity structure that defines a plurality of grooves formed on the face of the polymer liquid crystal layer, wherein liquid crystal molecules of the polymer liquid crystal layer are oriented in a lengthwise direction in which the plurality of grooves are formed on the of the face of polymer liquid crystal layer.

2. The polarization diffraction grating according to claim 1,
wherein the second concavity/convexity structure has a shape that suppresses light from diffracting at a relevant wavelength.

3. A method for manufacturing a polarization diffraction grating, the method comprising:
obtaining a polymer liquid crystal layer that includes a diffraction structure having a plurality of concavities and convexities, wherein the polymer liquid crystal layer is obtained by:
filling a mold having a concavity/convexity structure with polymerizable liquid crystal, wherein a surface of the concavity/convexity structure includes an orientation induction structure configured to induce orientation of liquid crystal molecules, and
polymerizing and curing the polymerizable liquid crystal;
detaching the polymer liquid crystal layer from the mold; and
obtaining an optically isotropic material layer by:
filling the diffraction structure having the plurality of concavities and convexities with an optically isotropic material, and
curing the optically isotropic material.

4. The method for manufacturing the polarization diffraction grating according to claim 3,
wherein the orientation induction structure is made up of a plurality of stripe-shaped grooves disposed parallel to each other, and a pitch of the orientation induction structure is set to be smaller than a pitch of the concavity/convexity structure.

5. An optical pickup apparatus comprising:
the polarization diffraction grating according to claim 1 disposed in an optical path between a light source and an objective lens.

6. The optical pickup apparatus according to claim 5,
wherein the light source is a semiconductor laser, and the polarization diffraction grating is disposed so as to be adjacent to the semiconductor laser on an optical axis.

7. An optical pickup apparatus comprising:
the polarization diffraction grating according to claim 2 disposed in an optical path between a light source and an objective lens.

8. The polarization diffraction grating according to claim 1,
wherein the plurality of grooves are formed parallel to each other.

9. The polarization diffraction grating according to claim 1,
wherein a pitch of the plurality of grooves is smaller than a pitch of the first concavity/convexity structure.

10. The polarization diffraction grating according to claim 9,
wherein a width of the plurality of grooves is smaller than a width of the first concavity/convexity structure.

11. The polarization diffraction grating according to claim 10, wherein
the pitch of the plurality of grooves is 0.32 μm and the width of the plurality of grooves is 0.16 μm; and
the pitch of the first concavity/convexity structure is 100 μm and the width of the first concavity/convexity structure is 50 μm.

12. The polarization diffraction grating according to claim 1,
wherein the lengthwise direction of the plurality of grooves is formed at an angle of approximately 45 degrees relative to a lengthwise direction in which the first concavity/convexity structure extends.

13. The method for manufacturing the polarization diffraction grating according to claim 3,
wherein, the orientation induction structure defines a plurality of grooves that formed parallel to each other.

14. The method for manufacturing the polarization diffraction grating according to claim 13,
wherein a pitch of the plurality of grooves is smaller than a pitch of the concavity/convexity structure.

15. The method for manufacturing the polarization diffraction grating according to claim 14,
wherein a width of the plurality of grooves is smaller than a width of the concavity/convexity structure.

16. The method for manufacturing the polarization diffraction grating according to claim 15, wherein
the pitch of the plurality of grooves is 0.32 μm and the width of the plurality of grooves is 0.16 μm; and
the pitch of the concavity/convexity structure is 100 μm and the width of the concavity/convexity structure is 50 μm.

17. The method for manufacturing the polarization diffraction grating according to claim 13,
wherein a lengthwise direction in which the plurality of grooves are formed extends at an angle of approximately 45 degrees relative to a lengthwise direction in which the concavity/convexity structure extends.
